(19) United States
(12) Patent Application Publication
(10) Pub. No.: US 2008/0007032 A1
(43) Pub. Date: Jan. 10, 2008

(54) Instrument panel assembly with airbag

(75) Inventors: Gary J. Sadek, Plymouth, MI (US); Katherine A. Shaw, Dearborn, MI (US); Nebojsa Miletic, Sterling Heights, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(73) Assignee: Lear Corporation

(21) Appl. No.: 11/483,281

(22) Filed: Jul. 7, 2006

(51) Int. Cl. B60R 21/205; B60R 21/215

(52) U.S. Cl. 280/728.3; 280/732

(57) ABSTRACT

An instrument panel assembly for a vehicle including a lower housing having a first portion and an upper panel separate from and attached to the lower housing. The upper panel defines a front edge and a rear edge. The rear edge is adjacent to the first portion of the lower housing and faces a passenger compartment of the vehicle. The upper panel is attached relative to the lower housing at first and second attachment locations. The rear edge and a portion of the upper panel are adapted to deform and move in a direction outwardly from the first portion of the lower housing to define a gap between the rear edge and the first portion of the lower housing to permit passage of a deployed air bag through the gap such that the upper panel remains attached to the lower housing at the first and second attachment locations.

### BACKGROUND OF THE INVENTION

This invention relates in general to vehicle components, and in particular to instrument panel assemblies having airbag assemblies mounted therein. There is illustrated in FIG. 1, a prior art instrument panel assembly, indicated generally at 10, viewed from a passenger compartment of a vehicle. The instrument panel assembly 10 is installed into the vehicle and generally extends across the width of the passenger compartment. The vehicle further includes a windshield 12, and a pair of A-pillar trim panels 14 mounted adjacent lateral sides of the windshield 12. The A-pillar trim panels 14 generally cover elongated frame members (not shown) disposed along the lateral edges of the windshield and generally extend upward from a cowl frame member (not shown) located in front of the instrument panel 10 and a roof (not shown) of the vehicle. The vehicle also includes a passenger side airbag 16 which is shown in its partially deployed position.

The instrument panel 10 includes a generally flat upper panel 20 and a lower housing 22. The upper panel 20 includes a front edge 24 and a rear edge 26. The rear edge 26 generally faces the passenger compartment of the vehicle and generally extends along the entire width of the upper panel 20. The upper panel 20 is pivotally attached to the lower housing 24 generally along the front edge 24. As will be described below, the upper panel 20 is pivotable between a non-deployed and a deployed position. The upper panel 20 is shown in its deployed position in FIG. 1. When in the non-deployed position, the upper panel 20 is in a generally horizontally oriented position above the lower housing 22. In this non-deployed position, the upper panel 20 covers an opening 30 of the upper portion of the lower housing 22. When in the deployed position, the entire rear edge 26 of the upper panel 20 has been lifted generally against the windshield 12 to permit the airbag 16 to be deployed through the opening 30 above the lower housing 22, as shown in FIG. 1. The upper panel 22 includes an under surface 34, which is shown exposed in FIG. 1. When the upper panel 20 is in its non-deployed position, the under surface 34 faces generally downward.

The rear edge 26 of the upper panel 20 is connected to the lower housing 22 by break away fasteners (not shown). During deployment of the airbag 16, the force from the expansion of the airbag causes the break away fasteners attaching the rear edge 26 of the upper panel 20 to deform and separate from the lower housing, thereby permitting the upper panel 20 to lift upward pivoting generally about the front edge 24 to expose the opening 30. The airbag 16 will continue to deploy upwardly through this opening 30 to its fully inflated state. After the airbag 16 has deflated, the upper panel 20 is permitted to fall downward back onto the lower housing 22. Note that the upper panel 20 is located between the A-pillar trim panels 14 when in its deployed position. When in the deployed position, lateral edges 40 and 42 of the upper panel 20 are disposed adjacent the A-pillar trim panels 14 such that the upper panel 20 is located between and adjacent the A-pillar trim panels 14. Thus, the A-pillar trim panels 14 are prevented from being moved in a lateral direction towards each other.

### SUMMARY OF THE INVENTION

This invention relates to an instrument panel assembly for a vehicle including a lower housing having a first portion and an upper panel separate from and attached to the lower housing. The upper panel defines a front edge and a rear edge. The rear edge is, adjacent to the first portion of the lower housing and faces a passenger compartment of the vehicle. The upper panel is attached relative to the lower housing at first and second attachment locations. The rear edge and a portion of the upper panel are adapted to deform and move in a direction outwardly from the first portion of the lower housing to define a gap between the rear edge and the first portion of the lower housing to permit passage of a deployed air bag through the gap such that the upper panel remains attached to the lower housing at the first and second attachment locations.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic elevational view of a passenger compartment of a vehicle illustrating a prior art instrument panel assembly mounted therein.

FIG. 2 is a schematic elevational view of a passenger compartment of a vehicle illustrating an embodiment of an instrument panel assembly mounted therein, wherein the upper panel of the instrument panel is shown in the non-deployed position.

FIG. 3 is a schematic elevational view of the instrument panel assembly and passenger compartment of FIG. 1, wherein the upper panel of the instrument panel is shown in the deployed position.

FIG. 4 is a cross-sectional view of the instrument panel assembly taken along lines 4-4 of FIG. 2.

FIG. 5 is a cross-sectional view of the instrument panel assembly taken along lines 5-5 of FIG. 4.

FIG. 6 is a cross-sectional view of the instrument panel assembly similar to FIG. 4, wherein the upper panel is shown in its deployed position.

FIG. 7 is a cross-sectional view of the instrument panel similar to FIG. 5,. wherein the upper panel is shown in its deployed position.

### DETAILED DESCRIPTION OF THE PREFERRED EMBODIMENT

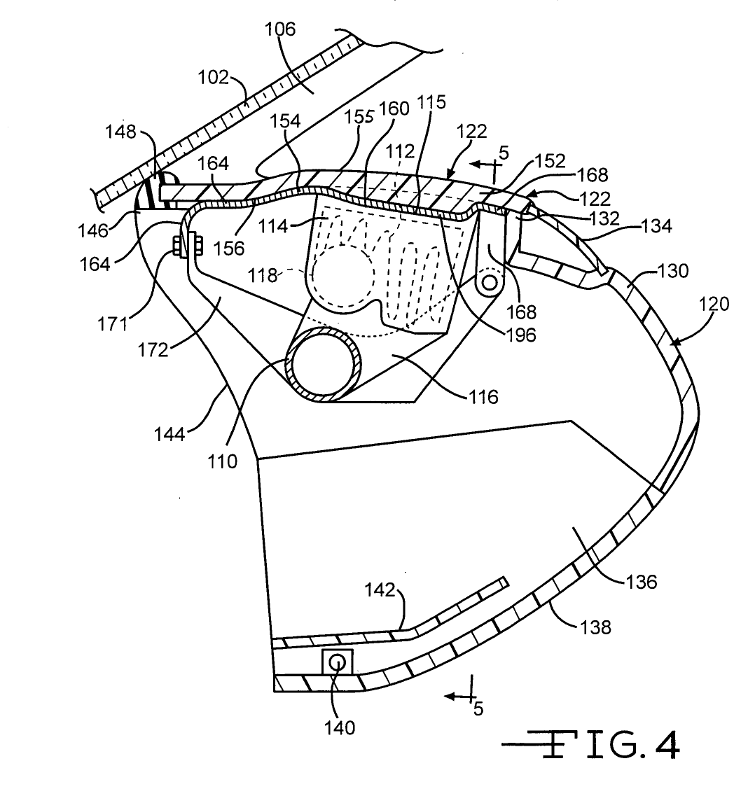

Referring now to the drawings, there is illustrated in FIG. 2 an instrument panel assembly, indicated generally at 100, viewed from a passenger compartment of a vehicle. The vehicle also includes a windshield 102 and a pair of A-pillar trim panels 104 and 106. The A-pillar trim panels 104 and 106 are mounted on A-pillar frame members (not shown) adjacent to the lateral sides of the windshield 102. The A-pillar trim panels 104 and 106 generally cover elongated A-pillar frame members (not shown) disposed along the lateral edges of the windshield 102. These elongated A-pillar frame members generally extend upward from a cowl frame member (not shown) located in front of the instrument panel 100 and a roof (not shown) of the vehicle. The vehicle may also include a headliner (not shown) mounted under the roof. The vehicle may further include deployable air curtains (not shown) which are mounted at lateral edges of the headliner. The air curtains may be deployable, such as during an impact, in which they are rapidly inflated downward from the lateral edges of the headliner to help protect the head, neck, and upper body portion of passengers within the vehicle. The lateral edges of the headliner may deflect downward and inward towards the center of the passenger compartment of the vehicle to provide clearance for the deployed air curtain. If upper portions of the A-pillar trim panels 104 and 106 are mounted over the lateral edges of the headliner, the A-trim panels may be releasably mounted on the A-pillar frame members so that they may deflect or move inwardly towards the passenger compartment, thereby permitting clearance for the lateral edges of the headliner and the deploying air curtains. For example, the A-pillar trim panel 104 may move rightward, as viewing FIGS. 2 and 3. The A-pillar trim panel 106 may move leftward, as viewing FIGS. 2 and 3.

The instrument panel assembly 100 generally includes a driver side portion 107 and a passenger side portion 109. The instrument panel assembly 100 may extend generally across the entire width of the passenger compartment. The instrument panel assembly 100 may also include a cross car beam 110 mounted therein, which may extend generally across the entire width of the passenger compartment. The cross car beam 110 is preferably a relatively strong and rigid straight tubular beam. In the embodiment shown in FIGS. 2-7, the cross car beam 110 has a generally constant circular cross-section. The cross car beam 110 helps reduce the crumpling of side frame members and doors of the vehicle from entering into the passenger compartment upon a side impact collision of the vehicle. As best shown in FIG. 2, a deployable airbag 112 is mounted on the passenger side 104 of the instrument panel assembly 100. Of course, the airbag 112 may be mounted anywhere in the instrument panel assembly 100. The airbag 112 is mounted in a folded state within an airbag housing 114. The airbag housing 114 may be attached to the cross car beam 110 by brackets 116. The upper portion of the airbag housing 114 includes an opening 115 formed in an upper portion thereof. An inflator assembly 118 is mounted in the housing 114 and may be any conventional airbag inflator mechanism capable of generating gases for properly inflating the airbag 112.

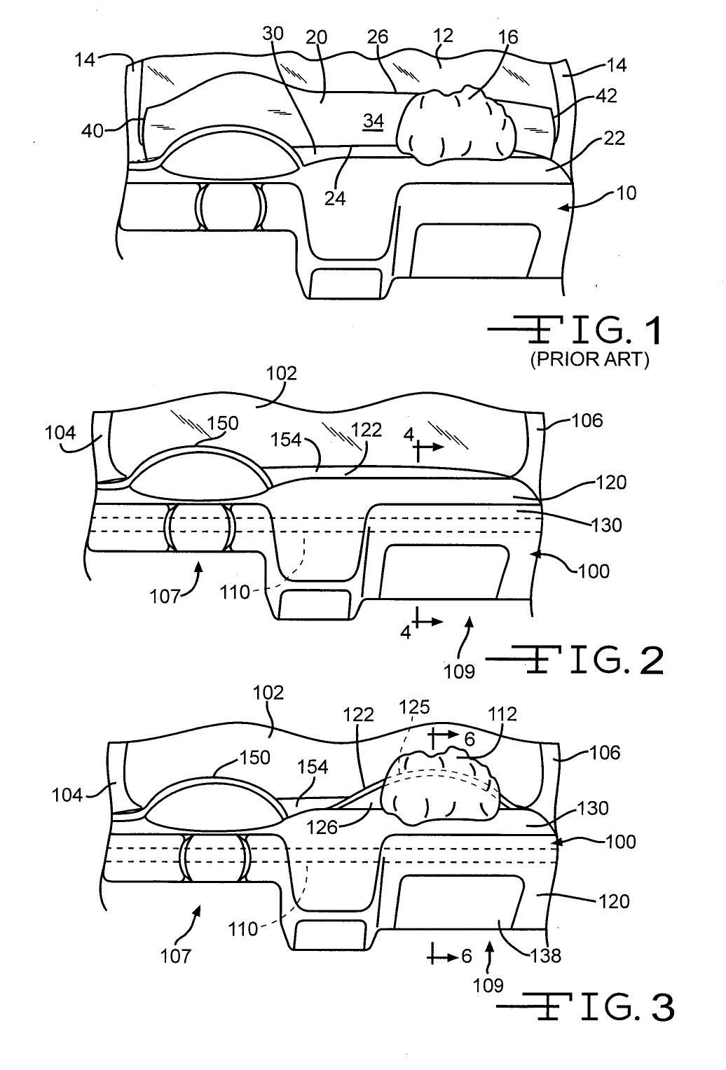

The instrument panel assembly 100 generally includes a lower housing 120 and an upper panel 122. The upper panel 122 may have a generally flat shape and is disposed above the lower housing 120. In one embodiment of the instrument panel assembly 100, the lower housing 120 and the upper panel 122 generally extends across the entire width of the passenger compartment. The cross car beam 110 is generally mounted within the lower housing 120 and the ends thereof are connected to side frame members (not shown) of the vehicle. If desired, the cross car beam 110 may be connected to an intermediate bracket 123 which is connected to the side frame members of the vehicle. The intermediate bracket 123 may close off the end of the lower housing 120 and be attached thereto. The airbag housing 114 and airbag 112 are generally mounted under the upper panel 122. As will be explained below in more detail, during deployment of the airbag 112, a deformable region 125 of the upper panel 122 deforms and/or stretches to create a gap 126, as shown in FIGS. 3, 6, and 7, between the upper panel 122 and the lower housing 120 to permit passage of the deploying airbag 112 through the gap 126. In the embodiment of the upper panel 122 shown in FIGS. 2-7, the deformable region 125 generally corresponds to a rearward portion of the upper panel located at the passenger side portion 109, although such is not required. This deformable movement is in contrast to the prior art instrument panel assembly 10 of FIG. 1, wherein the entire upper panel 20 hinges forward against the windshield 12 to permit the airbag 16 to be deployed through the opening 30 between the lower housing 22 and the upper panel 20.

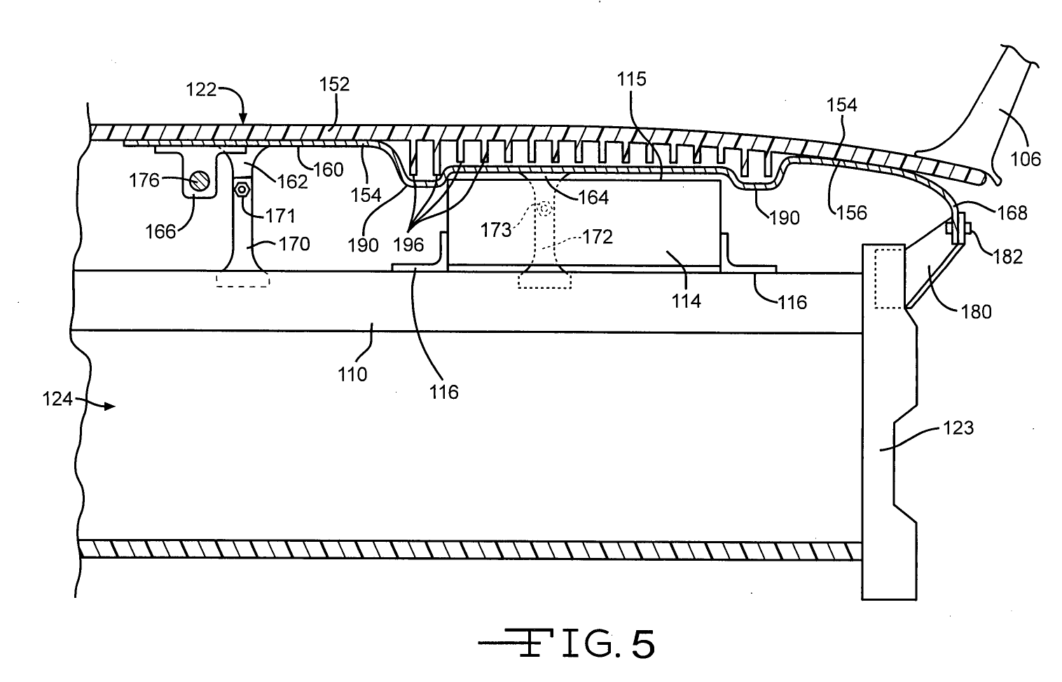

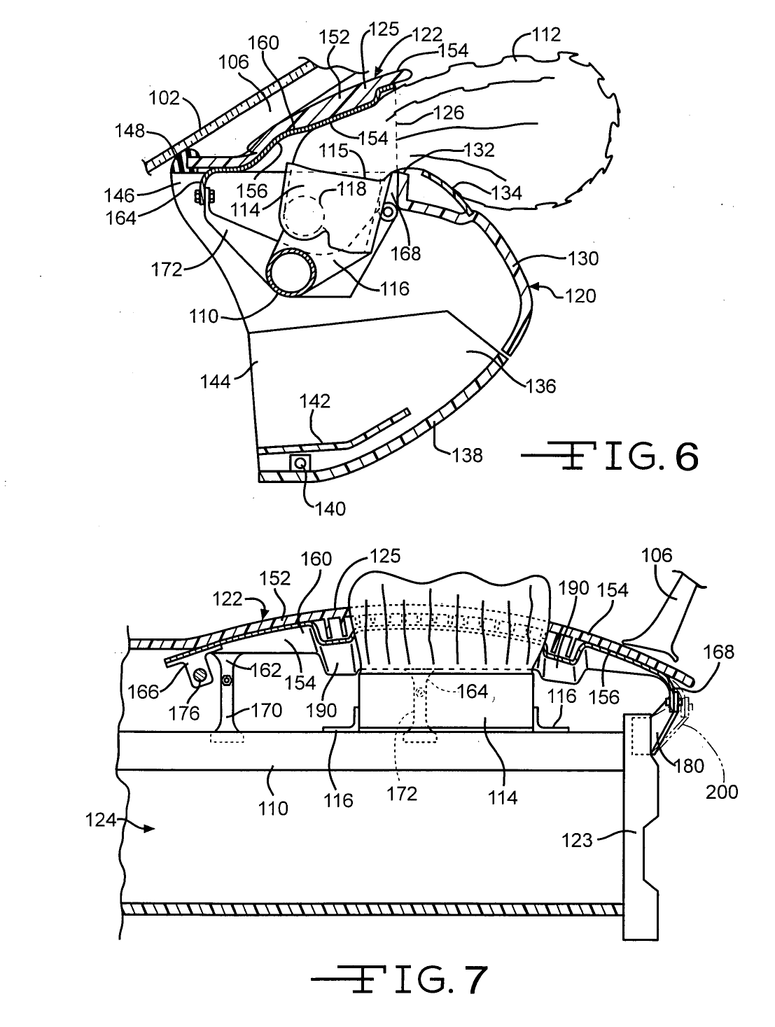

As best shown in FIGS. 4 and 5, the lower housing 120 has a generally hollow shape defining an interior therein for housing various vehicular components (not shown). The lower housing 120 generally includes a main portion 130 which faces rearwardly, rightward as viewing FIG. 4, towards the passenger compartment of the vehicle. The main portion 130 has an upper portion or edge 132. The lower housing 120 may also include a decorative panel 134, as shown in FIGS. 4 and 6, such as a faux wood plastic panel or other decorative panel mounted on the main portion 130. The lower housing 120 may include a glove box or storage compartment, indicated generally at 136. The storage compartment 136 includes a door 138 generally pivotable about a pivot pin 140. The storage compartment further includes a lower shelf 142. The lower housing 120 has an open front portion 144 facing forwardly toward the engine compartment (not shown) of the vehicle. The front portion 144 has an upper portion 146 which may be connected to a cowl frame member and/or seal 148 disposed against the windshield 102. It should be understood that the lower housing 120 can have any suitable shape.

The upper panel 122 has a generally flat shape but may have any suitable shape and configuration. For example, the upper panel 122 may have a bulged portion 150 for accommodating a driver's side instrument cluster (not shown). The upper panel is generally formed from a cover 152 and a reinforcement bracket 154. Preferably, the cover 152 is made of a material which is able to deform and/or stretch without fracturing, breaking, or separating apart during deployment of the airbag 112, as will be discussed below. The cover 152 may be made of plastic or a polymeric material. If desired, the cover 152 may include other layers or materials, such as an outer covering (not shown). The cover 152 has an upper surface 155 facing upward towards the windshield 102 and the passenger compartment. The cover 152 includes an underface 156 facing downward, as viewing FIG. 4, towards the lower housing 120.

The reinforcement bracket 154 is preferably made of a sheet of relatively strong material, such as metal, and may be formed from a stamped sheet. The reinforcement bracket 154 includes a centralized main portion 160 and a plurality of tabs or flanges 162, 164, 166, and 168 extending generally downward from the main portion 160. The main portion 160 may conform to the underface 156 of the cover 152 and is attached thereto. The reinforcement bracket 154 can be attached to the cover 152 by any suitable manner, such as by adhesive, heat stakes, welding, or fasteners. In one embodiment. The main portion 160 may be attached to the cover 152 by self piercing rivets (not shown). Self piercing riveting generally uses a plurality of metal rivets having structures which pierce through the reinforcement bracket 154 and engage the material of the cover 152 preferably without puncturing through the opposite surface of the cover 152. Preferably, the main portion 160 of the reinforcement bracket 154 remains attached to the cover 152 during full deployment of the airbag 112 although such is not required. The reinforcement bracket 154 preferably provides strength for the upper panel 122 and helps absorb the load transmitted to the upper panel 122 by the impact force of the rapidly expanding airbag 112. Preferably, the reinforcement bracket 154 helps in transferring the energy caused by the expansion of the airbag 112 into elastic and/or plastic deformation of the reinforcement bracket 154, thereby preferably leaving the lower housing 120 generally intact after the deployment of the airbag 112.

As shown in FIG. 4, the reinforcement bracket 154 generally includes a front portion 164 and a rear portion 166. The flanges 162 and 164 generally extend from the front portion 164. The flanges 166 and 168 generally extend from the rear portion 166. The flanges 162 and 166 generally extend from the front portion 164. The upper panel 120 is preferably attached to the cross bar beam 110 via the reinforcement bracket 154. However, it should be understood that the upper panel 120 may not be connected to the cross car beam 110, but instead to other portions of the vehicle, such as the lower housing 120 or various frame members (not shown) of the vehicle. The flange 162 is attached to the cross car beam 110 via a bracket 170. The flange 162 and the bracket 170 may be connected together by a fastener 171 or by any other suitable manner, such as by welding. The flange 164 is attached to the cross car beam 110 via a bracket 172. The flange 164 may be connected together by a fastener 173 or by any other suitable manner, such as by welding. The flange 166 is attached to the lower housing 120, such as by a pin or fastener 176. If desired, the flange 166 may be pivotally attached to the lower housing 120. The flange 168 is attached to the cross car beam 110 via a bracket 180. The bracket 180 may be made of material, such as stamped metal, and is preferably more rigid and stronger than the bracket 180. The bracket 180 is connected to the cross car beam 110 via the intermediate bracket 123. The flange 168 and the bracket 180 may be connected together by a fastener 182 or by any other suitable manner, such as by welding. In the embodiment of the instrument panel assembly 100 shown in FIGS. 2-7, there are four attachment locations for attaching the upper panel 122 to the lower housing 120 which are generally defined by the four flanges 162, 164, 166, and 168. It should be understood that the upper panel 122 can be connected to the lower housing 120 by any number of attachment locations which can be located at any suitable position.

The reinforcement bracket 154 further includes a pair of outwardly extending ridges 190 formed therein. The ridges 190 are spaced apart from each other in a parallel relationship. When in the non-deployed position of the upper panel 122, the ridges 190 extend downwardly towards the sides of the airbag housing 114.

The upper panel 122 preferably includes some form of energy absorbing structures. As best shown in FIG. 5, the embodiment of the upper panel 122 includes the energy absorbing structures in the form of a plurality of ribs 196 formed in the cover 152. Upon impact, such as by a portion of the body of a passenger in the vehicle, the ribs 196 may deform and crush, thereby absorbing or dissipating some of the force generated by the impact.

The operation of the instrument panel assembly 100 during deployment of the airbag 112 will now be discussed. FIGS. 4 and 5 illustrate the airbag 112 in its non-deployed position. The upper panel 122 is also in its non-deployed position in FIGS. 4 and 5 such that the upper panel 122 is positioned above the lower housing 120 and generally covers the edge 132 of the main portion 130 of the lower housing 120. The upper panel 122 is also positioned above the airbag housing 114. Upon detection of an impact condition in which the airbag 110 is to be deployed, a controller (not shown) energizes the inflator assembly 118 to provide a rapid discharge of gas into the interior of the airbag 112. The entry of gas into the airbag causes the airbag 112 to unfold and expand through the opening 115 of the airbag housing 114. The force of the expanding airbag 112 causes the deformable portion 125 of the upper panel 122 to lift upwardly from the lower housing 120 thereby creating the gap 126 between the edge 132 of the lower housing 120 and the upper panel, as shown in FIGS. 6 and 7. The gap 126 expands as the airbag 112 expands therethrough. The airbag 112 is shaped so as to unfold and be expelled through the gap 126 and directed toward the passenger compartment for protection of a person in the passenger side of the passenger compartment. The airbag 112 is shown partially inflated in FIGS. 3 and 6. The flanges 162, 164, 166, and 168 generally function as tie downs or anchorage points for the upper panel 122 and generally define the deformable region 125 of the upper panel 122 therebetween. The ridges 190 formed in the reinforcement bracket 154 function as guides to help properly direct the airbag 112 through the gap 126 towards the passenger compartment, thereby assisting in preventing the airbag 112 from being directed to far in the lateral direction.

During deployment of the airbag 112, the upper panel 122 deforms and stretches to form the gap 126. It is noted that the upper panel 122 preferably remains attached to the lower housing 120 by the attachment locations defined by the flanges 162, 164, 166, and 168. Preferably, the cover 152 stretches and deforms such that the surface area of the upper surface 155 at the deformable region 125 increases. It is also preferred that the cover 152 does not fracture, break, or separate apart during this deformation.

The reinforcement bracket 154 also deforms to create the gap 125. The reinforcement bracket 154 may or may not stretch during deployment of the airbag 112 and the upper panel 122. Instead of stretching, the flanges 162, 164, 166, 168 and brackets 170, 172, and 180 may deflect upward to permit the movement of the reinforcement bracket 154. The bracket 180 is preferably relative rigid and strong to help retain the flange 168 and adjacent portion of the reinforcement bracket 154 from being lifting substantially upward during deployment of the airbag. However, it should be understood that the flange 168 and bracket 180 may move slightly, as shown in FIGS. 5 and 7. This movement is represented in FIG. 7, by broken lines 200 representing the initial position of the bracket 180 as shown in FIG. 5 prior to deployment of the airbag 112. Due to this relatively small movement of the bracket 180 and the flange 168, the A-trim panel 106 may be moved leftward, as shown moved in FIG. 7, over the upper panel 122 such as for example to permit the expansion of an air curtain (not shown) of a headliner, as described above.

After a relatively short time period, the airbag 112 may self deflate permitting the upper panel 122 to move back towards the lower housing 120. The lower panel 122 may or may not be moved back to its original non-deployed position due to any stretching and/or deformation of the cover 152, reinforcement bracket 154, the flanges 162, 164, 166, and 168, and the brackets 170, 172, and 180. The plurality of ribs 196 may function as energy absorbing structures in the event of the occupant being directed towards the upper panel 122 either during or after the deployment of the airbag 112.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. An instrument panel assembly for a vehicle, said assembly comprising:
a lower housing having a first portion; and
an upper panel separate from and attached to said lower housing, said upper panel defining a front edge and a rear edge, said rear edge being adjacent to said first portion of said lower housing and facing a passenger compartment of a vehicle, said upper panel being attached relative to said lower housing at first and second attachment locations, wherein said rear edge and a portion of said upper panel are adapted to deform and move in a direction outwardly from said first portion of said lower housing to define a gap between said rear edge and said first portion of said lower housing to permit passage of a deployed air bag through said gap such that said upper panel remains attached to said lower housing at said first and second attachment locations.

2. The assembly of claim 1 further including an air bag deployable through said gap during deformation of said upper panel.

3. The assembly of claim 2, wherein said air bag is mounted on said lower housing.

4. The assembly of claim 1, wherein said first portion of said lower housing is located between said first and second attachment locations.

5. The assembly of claim 1, wherein said front edge is attached to said lower housing, and wherein said front edge generally remains attached and unmoved relative to said lower housing during deployment of the air bag.

6. The assembly of claim 1, wherein said upper panel is further attached to said lower housing at a third attachment location.

7. The assembly of claim 1 further including a reinforcement bracket attached to said first portion of said upper panel.

8. The assembly of claim 7, wherein said upper panel defines a lower surface facing said lower housing, and wherein said reinforcement bracket is attached to said lower surface.

9. The assembly of claim 8, wherein said lower surface of said upper panel includes a plurality of energy absorbing structures formed therein.

10. The assembly of claim 7, wherein said reinforcement bracket is attached to said upper panel and said lower panel at said first and second attachment locations, wherein said reinforcement bracket is adapted to move concurrently with said upper panel and deform in a direction outwardly from said lower housing between said first and second attachment locations to permit passage of a deployed air bag between said reinforcement bracket and said lower housing such that said upper panel and said reinforcement panel remain attached to said lower housing at said first and second attachment locations.

11. The assembly of claim 7 further including a cross car beam attached to said lower housing.

12. The assembly of claim 11, wherein said reinforcement bracket is attached to said cross car beam at one of said first and second attachment locations.

13. The assembly of claim 11 further including a mounting bracket separate from said reinforcement bracket and attaching said reinforcement bracket to said cross car beam at said first attachment location.

14. The assembly of claim 13, wherein said reinforcement bracket is attached to said lower bracket at said second attachment location.

15. The assembly of claim 13, wherein said mounting bracket is further attached to said lower housing and said upper panel at said second attachment location

16. The assembly of claim 6, wherein said reinforcement bracket includes an outwardly extending ridge for guiding the deployment of the air bag.

17. The assembly of claim 6, wherein said reinforcement bracket includes a pair of outwardly extending ridges for guiding deployment of the air bag therebetween, wherein said pair of outwardly extending ridges are generally parallel with one another.

18. The assembly of claim 6 further including an air bag deployable between said rear edge and the said lower housing during deformation of said reinforcement bracket and said upper panel.

19. The assembly of claim 18, wherein said air bag is mounted on said lower housing.
